(19) United States
(12) Patent Application Publication
(10) Pub. No.: US 2014/0258185 A1
(43) Pub. Date: Sep. 11, 2014

(54) METHOD FOR REVEALING A TYPE OF DATA

(71) Applicant: Raam Sharon, Nes Ziona (IL)

(72) Inventor: Raam Sharon, Nes Ziona (IL)

(21) Appl. No.: 13/788,808

(22) Filed: Mar. 7, 2013

(51) Int. Cl. G06N 99/00

(52) U.S. Cl. CPC G06N 99/005
USPC 706/12

(57) ABSTRACT

A method for revealing a type of data is provided herein. The method is comprising
the following steps (i) receiving at least one training data set of objects to create a signature for that data type; (ii) creating the signature, by: (a) scanning all objects in
   each training data set, to create a list of unique N-Grams of any size and their statistics; and (b) adding each N-Gram in the list in case it appears in a minimum of predefined threshold objects to a repository; (iii) receiving data of unknown type for examination; (iv) scanning said received data of unknown type to score each N-Gram
   in the signature of each object type when it is found in the scanned data; and (v) determining the type of the unknown type data according to the signature of the object type that accumulated highest score by the N-Grams of the signature.

### FIELD OF THE INVENTION

The present invention relates generally to the field of identifying a type of a code or an object type that is received by application software.

### BACKGROUND OF THE INVENTION

Identifying the type of a code, whether it is in a file or byte stream, is a challenge that many software companies are facing.

Many applications, security and others, base their behavior on the type of code they receive as an input. Today's traditional identification methods rely on file extensions, magic numbers, propriety headers and trailers or specific type identifying rules. While the first methods are vulnerable to content tampering, the last one requires investing in long and tedious working hours of professionals. Therefore, there is a need in a method which overcomes content manipulation problem and is automated to save expensive professional efforts.

### BRIEF DESCRIPTION OF THE DRAWINGS

The present invention will be more readily understood from the detailed description of embodiments thereof made in conjunction with the accompanying drawings of which:

FIG. 1 shows a flowchart of a signature creation from a training data repository, according to some embodiments of the present invention;

FIG. 2 shows a flowchart of a process of removing outliers, according to some embodiments of the present invention;

FIG. 3 shows a flowchart of process of grouping to Centroids in training data preparation for each type, according to some embodiments of the present invention;

FIG. 4 shows a flowchart of scanning a subset of a file for signature creation by a predefined pattern, according to one embodiment of the present invention;

FIG. 5 shows a flowchart of scanning data of unknown type for examination with same pattern as was used to create signature, according to some embodiments of the present invention;

FIG. 6 shows a flowchart of a process of building a tree of N-Grams for a type signature creation, according to some embodiments of the present invention;

FIGS. 6A-6E demonstrates an example of the process of building a tree of N-Grams for a type signature creation, according to some embodiments of the present invention;

FIG. 7 shows a flowchart of a process of setting max N-Gram in a signature, according to some embodiments of the present invention;

FIG. 8 shows a flowchart of a process of creating an extended object type signature based on the result of inspecting all object training sets using the basic signature that was created for the object type, according to some embodiments of the present invention;

FIG. 9 shows a process of adding an extended signature of one type or sub type to the extended signature of all types.

FIG. 10 shows a flowchart of the process of scanning an object of unknown type and determining its type by calculating its score using the extended signature created using the process described in FIG. 8.

FIG. 11 shows a table where each pair of rows presents the Average Score and Standard Deviation of all types training sets for a specified type signature;

FIG. 12 shows a graph which presents the result of the table in FIG. 11;

FIG. 13 shows the results of all type signatures for the type training set of JPG;

FIG. 14 shows scores that an object may receive;

FIG. 15 shows that the distance of the object from the type ‘epub’ is the smallest, hence, the best guess is that the object is of type ‘epub’; and

FIG. 16 shows a graph illustrating the distance.

### SUMMARY OF THE INVENTION

According to some embodiments of the present invention, a method for revealing a type of data is provided herein. The method is comprising the following steps: (i) receiving at least one training data set of objects to create a signature for that data type; (ii) creating the signature, by: (a) scanning all objects in each training data set, to create a list of unique N-Grams of any size and their statistics; and (b) adding each N-Gram in the list in case it appears in a minimum of predefined threshold objects to a repository. Each signature includes at least one N-Gram, wherein size of the at least one N-Gram is variable having a minimum limitation and a temp maximum value is specified for the size of the at least one N-Gram, and the temp maximum value for the size of the at least one N-Gram is increased after the creating of the signature when at least one identified N-Gram in the creation process reach the temp maximum value. (iii) receiving data of unknown type for examination; (iv) scanning said received data of unknown type to score each N-Gram in the signature of each object type when it is found in the scanned data; and (v) determining the type of the unknown type data according to the signature of the object type that accumulated highest score by the N-Grams of the signature.

According to some embodiments of the present invention, the method is further comprising the step of defining a range of thresholds for maximum standard deviation and removing objects not in the range of threshold in the signature creating step from a training data set.

According to some embodiments of the present invention, in the creating of the signature, order of the objects that are being scanned is determined according to size of the objects.

According to some embodiments of the present invention, the scanning of: (i) each object in the training data set to create a signature; and (ii) said received data of unknown type, is applied on fractional sections of the object by using a predefined scanning pattern which defines the relative location and size of each section.

According to some embodiments of the present invention, an N-gram that appears in more than one type signature receives a low score.

According to some embodiments of the present invention, the creating of one type signature is from multiple signatures.

According to some embodiments of the present invention, settings are applied for specified object types.

According to some embodiments of the present invention, the creating of the signature is utilizing a data structure of a tree structure, wherein each node includes one byte and represents one potential N-Gram beginning at the root of the tree.

According to some embodiments of the present invention, through the signature creation processing (which includes scanning) new nodes are added to the tree in case the number of appearances of the corresponding N-gram in all scanned objects is with the limits of predefined threshold.

According to some embodiments of the present invention, after scanning each object, trimming nodes which their corresponding N-gram number of appearances in all scanned objects is not with the limits of predefined threshold.

According to some embodiments of the present invention, the preparing of the training data set is comprising the steps of: (i) creating one group of objects (i.e. centroid) for each object in the training data set and keeping it in the first data storage; (ii) for each centroid pairs in the first data storage, calculating the signature of an intersection of the centroids, then repeatedly taking the following steps, while there is more than one centroid left in the first data storage:
a) selecting an ordered pair of centroids from the first data storage yielding the best signature by intersection,
b) merging the ordered pair of centroids to yield a new centroid;
c) keeping the new centroid in the first data storage;
d) copying the new centroid with its related signature to the second data storage;
e) removing the ordered pair of centroids that was used to create the new centroid from the first data storage; and
f) repeatedly calculating the signatures for the intersection of the new centroid and each of the rest of the centroids in the first data storage.
   (iii) selecting centroids from the second data storage, in reverse order of creation, as training data sets in case: (a) the signature of the centroid meets predefined criteria; and (b) the centroid is not included in another centroid that was selected earlier.

According to some embodiments of the present invention, during the signature creation, after scanning each object checking each N-Gram that was added to the repository and removing all N-Grams that appear in less objects in the training data set than the N-Grams in objects' threshold.

According to some embodiments of the present invention, during the signature creation, for each object type, N-Grams are sorted by specified criteria for contribution to the type signature and N-Grams having low contribution to the type signature are removed.

According to some embodiments of the present invention, the method is further comprises the steps of scanning each training data set of each type signature using signatures of all types and, calculating an average score and standard deviation of all objects in the training data sets and saving it as an attribute of the signature used for scanning the training data set.

According to some embodiments of the present invention, the method is further comprises the step of: calculating distance parameters of the score of examined object by signature from the average scores taking into account standard deviations received by scanning each type training data set by the alleged signature.

According to some embodiments of the present invention, the method is further comprising the step of: summing up the distance parameters for each type training data set and selecting the type where the result of the respective type training data set is the lowest.

According to some embodiments of the present invention, the method is further recreating the signature after temp maximum value for the size of the at least one N-Gram is increased.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Identifying a type of a code, or a type of object, whether in a file or a byte stream, is a challenge that many software companies are facing. Many software applications such as security applications and other software applications, base their response on the type of code they receive as an input.

The present invention, in some embodiments thereof, provides a method that is based on the idea of finding repeating N-Grams in a code in objects in a training data set. The objects share a common attribute such as type, network stream of a specific application such as Skype or MSN, DNA code of people from the same origin etc.

In the following application the term “N-Gram” relates to a contiguous sequence of n items from a given sequence of data represented as code. The data may be text, binary file content, network stream etc. For example, if the code is represented by ‘abcdaabb’ then ‘a’ is a 1-Gram that is repeating 3 times, ‘A’ is a 2-Gram that is repeating 2 times, ‘abcdaabb’ is an 8-Gram that is repeating 1 time and so on.

In the following application the term “signature” relates to a collection of N-Grams and statistical information related to them, in a training data set that meet predefined criteria. In case of the extended signature, more data may apply.

Today's traditional identification methods of a code type or an object type rely on file extensions, ‘magic’ numbers, propriety headers and trailers or specific type identifying rules. Some of these options, such as file extension and magic numbers are vulnerable to content tampering. Other methods, like creating specific type identifying rules require long and tedious working hours of professionals. This present invention describes a method of creating a signature for each type of object, based on training data set of the same object type, and using it to reveal the type of code when it is unknown.

The size of the N-Gram i.e. value of N, is variable and depends solely on the findings in the training data set. Limitations that may be applied are: (i) minimum size of N-Gram to achieve minimum signature strength; and (ii) maximum size, to address required memory size issues.

Statistical details for each N-Gram are collected while collecting N-Gram information for the objects in the training data set. These statistics are part of the signature and are used as an input for rules in the scanner, that determine the weight to assign to an N-Gram, which was found in an object, of unknown type, that was scanned. These statistics may be (but not limited to) minimum and maximum occurrences, standard deviation, number of objects in the training data set that they were found in, physical locations in the object and so on.

Strength of an N-Gram may be determined by the number of types of objects it appears in. The assumption is that N-Gram significance is higher if it appears in less different types of objects. Therefore, the maximum number or types of objects that an N-Gram may appear in may be specified in order for the N-Gram to be taken into consideration.

The uniqueness of the present invention compared to content filtering for example is: (i) The N-Gram size N is variable and not constant where N is determent by the actual findings in the training data set and may change in a predefined range; (ii) there is no requirement for significance for the number of N-Grams in each file or object, meaning one appearance of a pattern in each is sufficient; and (iii) in some embodiments on the present invention, an object may be examined while it is streamed until the type is determined, meaning, there's no need in the whole data or file to determine the type of the file or object.

According to some embodiments of the present invention, there is provided a method for revealing a type of data.

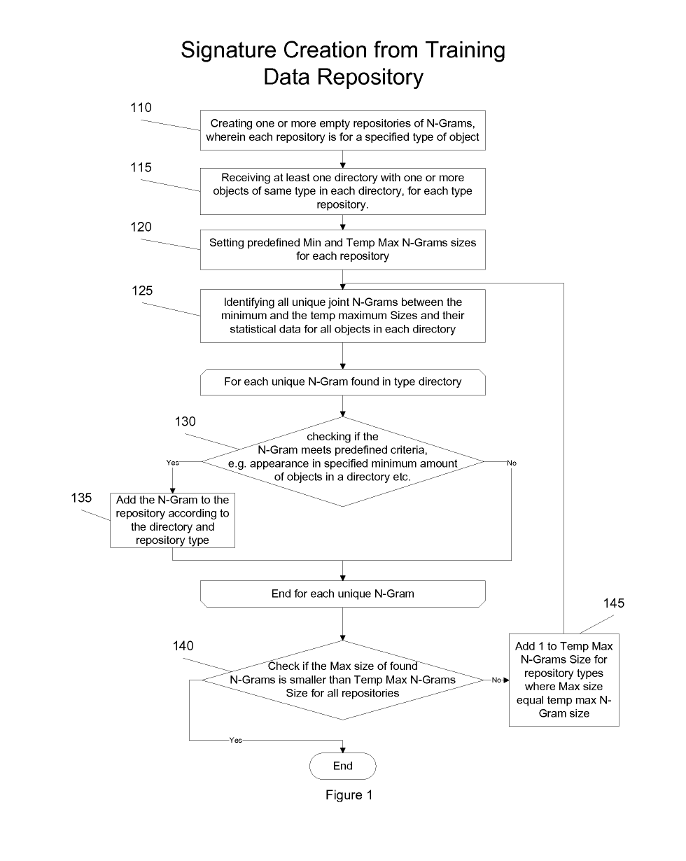

FIG. 1 shows a flowchart of a signature creation from a training data repository, according to some embodiments of the present invention.

According to some embodiments of the present invention, the process starts with creating one or more empty repositories of N-Grams. Each repository is for a specified type of object (stage 110). In next stage, receiving at least one directory with one or more objects of the same type in each directory, for each type repository. Each directory is a training data set for a type of object (stage 115). A preliminary step for stage 115 is identifying type of objects. As mentioned above, a predefined minimum size of N-Gram and a temporary maximum size of N-Gram may be set for each type repository (stage 120). Additionally, the temp maximum N-Gram size N is recalculated until the max available N-Gram size has been reached or reaching memory limit.

Iteration starts for all directories i.e. training data sets. For each directory it creates one type Signature. Identifying all unique joint N-Grams between the minimum and the temporary maximum sizes that were set in stage 120 and collecting their statistical data for all objects in each directory (stage 125). In other words, for each object (file for instance) in each directory, the process parses the content and extracts all N-Grams of all sizes that are meeting the minimum and maximum size limitations. The order of the objects that are being scanned is determined according to size of the objects for efficiency purposes. Since N-Grams are eliminated according to their absence from objects, scanning small objects first optimize memory usage and scanning efficiency.

According to some other embodiments of the present invention, each extracted N-Gram is inspected to verify that it meets predefined criteria to be included in the signature (stage 130). These requirements may be, but not limited to, (i) the number of objects in a training set that the N-Grams appears in; (ii) number of different object types signatures that the N-Gram is part of; (iii) average number of N-Grams in a file, the standard deviation of this value etc.

In case the N-Gram meets the specified criteria, it may be added to the type signature, with the statistics collected on it. In other words, the N-Gram is added to the repository that was created in stage 110 according to the directory and repository type (stage 135).

According to some embodiments of the present invention, after all N-Grams for each directory were verified as in stage 130, temporary maximum size of N-Gram is compared to the maximum size of N-Grams that were found for all repositories (stage 140). If the maximum size of found N-Grams is smaller than the temporary maximum that was set, for all N-Grams and all repositories, the process ends. In case the maximum size of some or all N-Grams that were found reached the temporary maximum size of N-Gram that was set in stage 120 (meaning, the maximum size of found N-Grams is not smaller than temporary maximum N-Gram size), then increasing temporary maximum size of N-Gram, for all repository types where the maximum size of found N-Grams is equal to the temporary maximum size of N-Gram (stage 145) and returning to step 125 for re-generating the signatures for the repositories where the temp max size was changed.

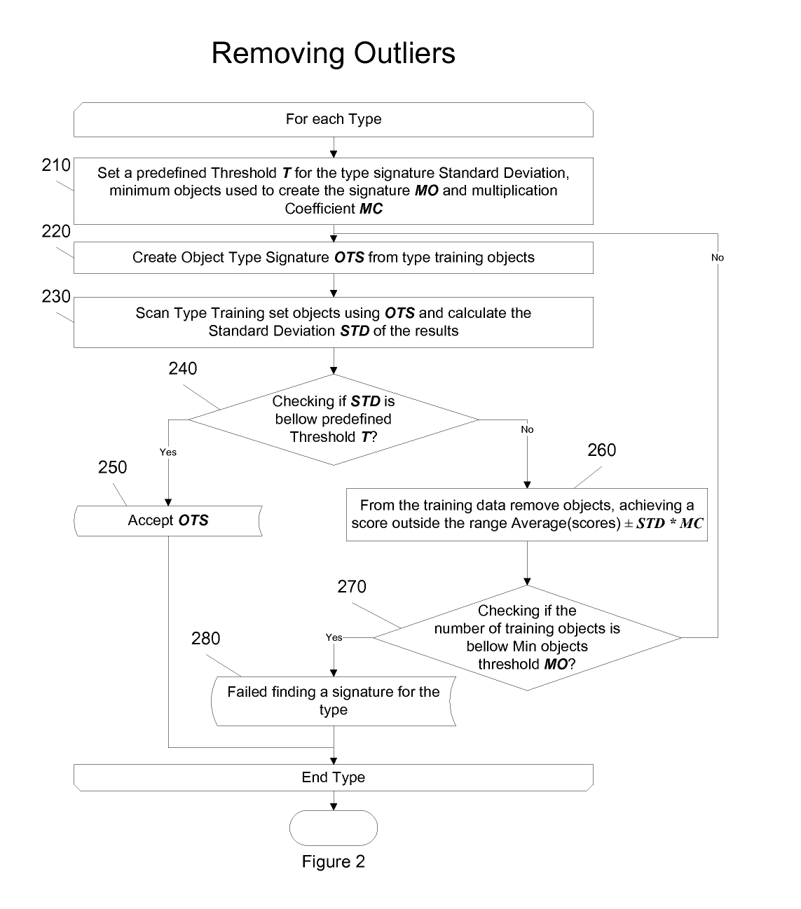

According to other embodiments of the present invention, as illustrated in FIG. 2, a flowchart of a process of removing outliers is performed.

After each type signature creation as illustrated in FIG. 1, a scan is performed on the training data set. By using the alleged signature i.e. signature that was created as illustrated in FIG. 1, scores are generated for each object in the training data set. Then, a standard deviation is calculated on the scores. If the standard deviation is bellow a predefined threshold, then the signature is accepted. Otherwise, a process of eliminating outliers takes place and if enough objects (more than a predefined minimum) are left after, then another iteration of signature creation and inspection takes place, until an acceptable signature is left or alternatively asserting that no signature can be created under the predefined limitations (i.e. criteria).

According to other embodiments of the present invention, for each type of object setting the following criteria: (i) a predefined threshold ‘T’ for the type signature standard deviation; (ii) minimum objects in a signature ‘MO’; and (iii) multiplication coefficient ‘MC’ (stage 210).

According to other embodiments of the present invention, creating object type signature ‘OTS’ from objects in training data set as illustrated in FIG. 1 (stage 220). Next, scanning the training data set that was used to create OTS using ‘OTS’ and calculating the standard deviation STD of the results (stage 230). The standard deviation is compared to the predefined threshold ‘T’ that was set in stage 210 to find out if it is below the threshold ‘T’ (stage 240). If the standard deviation “STD” is below the predefined threshold “T” then the ‘OTS’ (i.e. object type signature) is accepted (stage 250).

If the standard deviation is not below the predefined threshold ‘T’, meaning that there are objects which are considered as outliers and will be eliminated from the training data set. From the training data set remove objects, achieving a score outside the range of Average−(STD*MC) to Average+(STD*MC) (where MC is the multiplication coefficient that was set in stage 210) (stage 260).

According to other embodiments of the present invention, after stage 260 checking if the number of training objects is below minimum objects threshold ‘MO’ that was set in stage 210 (stage 270). If the number of training objects left in the training data set is not below minimum objects threshold ‘MO’ that was set in stage 210, returning to step 220 and repeating the process from there. If the number of training objects in a training data set is below the threshold ‘MO’ that was set in stage 210, then determining that a signature for the type object was not found (stage 280).

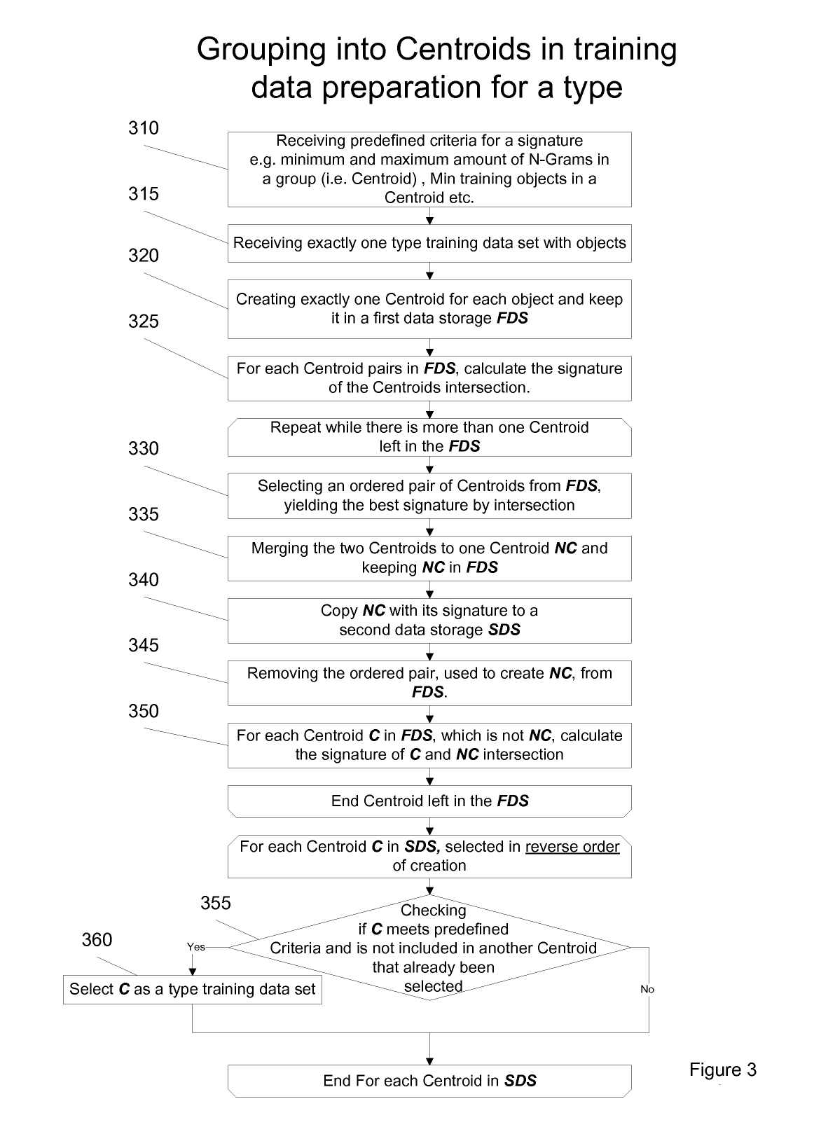

FIG. 3 shows a flowchart of process of grouping in training data preparation (Centroid) for each type, according to some embodiments of the present invention.

In some cases, a training data set may be constructed from a group of inhomogeneous objects. In extreme cases this may be a result of objects, not belonging to the same type. In another case, a type may be a common title for many other sub types. For instance, a Word 2003 document file structure is totally different than Word 2010 document, but still they both are Word documents. The result of using a training data set of such nature may result in a signature, which is weak in the best i.e. too few common N-Grams or not usable at worst i.e. no N-Grams in common between training data set objects. This optional step presents a solution.

This process prepares the training data set for a single type signature creation. It creates groups of objects (called Centroids) based on best merge results. It then picks up the best Centroids that meet predefined limitations such as minimum and maximum N-Grams in a signature, total size of all N-Grams etc. Additional limitation is that selected Centroids will not overlap, meaning that if a Centroid was picked, no other Centroid, which is contained in it will be picked. The main contribution of this process is in eliminating outlier files by grouping files with similar structure in a Centroid and leave outliers outside of the Centroid. Additionally, the process also allows unifying signature characteristics between different types by selecting Centroids that meet specific criteria, e.g. setting strict number of N-Grams in a signature. Signature representing an object type may be created from one or more Centroids, so multiple Centroids representing sub types may be related to the same type title. For example, Microsoft Word document type of 2003 and Microsoft Word document type of 2010 may be related to general Microsoft Word document. The signature in this case may be constructed using one or more Centroids for Word 2003 Document and one or more Centroids for Word 2010 Document.

According to some embodiments of the present invention, receiving predefined criteria for a signature (stage 310). For example, criteria may be minimum and maximum amount of N-Grams in a Centroid. Another example, minimum training objects in a Centroid. Next, receiving exactly one type of training data set with objects in it (stage 315).

According to some other embodiments of the present invention, creating exactly one Centroid for each object in the data set and keeping the Centroid in a first data storage ‘FDS’ (stage 320).

According to some other embodiments of the present invention, for each Centroid pairs in ‘FDS’ (i.e. first data storage) calculating the signature of the intersection of the Centroids (stage 325). Next, while there is more than one Centroid left in the ‘FDS’ repeat the following stages, stage 330 till stage 350.

Selecting an ordered pair of Centroids from ‘FDS’ to yield the best signature by intersection (stage 330). Next, merging the two Centroids to one Centroid ‘NC’ and keeping ‘NC’ in ‘FDS’. Next copying ‘NC’ with its signature to a second data storage ‘SDS’ (stage 340). After ‘NC’ was copied to ‘SDS’ (i.e. second data storage), removing the ordered pair, used to create ‘NC’, from ‘FDS’(i.e. first data storage) (stage 345). Next, for each Centroid ‘C’ in ‘FDS’ that is not ‘NC’ calculating the signature of the intersection of ‘C’ and ‘NC’ (stage 350).

According to some other embodiments of the present invention, after iteration of stages 330 till stage 350 ended, meaning there is not more than one Centroid left in the ‘FDS’, for each Centroid ‘C’ in ‘SDS’ selecting in reverse order of creation as mentioned in stage 340, checking if ‘C’ meets predefined criteria and is not included in another Centroid that has already been selected (stage 355). In case, ‘C’ meets predefined criteria and is not included in another Centroid that has already been selected, selecting ‘C’ as another training data set of a specific type object (stage 360). In case, ‘C’ doesn't meet predefined criteria or is included in another Centroid that has already been selected continue to select the next Centroid in SDS.

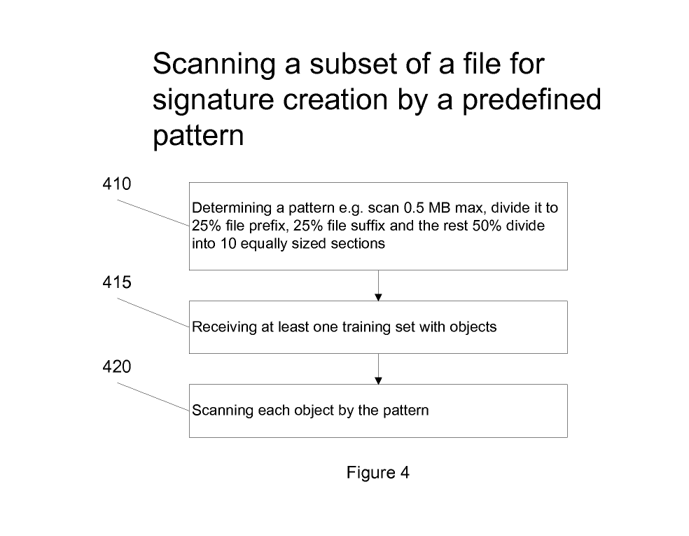

FIG. 4 shows a flowchart of scanning a subset of an object for signature creation by scanning using a predefined pattern, according to one embodiment of the present invention.

According to some embodiments of the present invention, a pattern may be determined (stage 410). For example, the pattern may be scanning 0.5 MB maximum, divide it to 25% file prefix, 25% file suffix and the rest 50% of the file may be divided into 10 equally sized sections.

According to some other embodiments of the present invention, at least one training data set with objects may be received (stage 415). Next, scanning each object in the training data set by the pattern (stage 420).

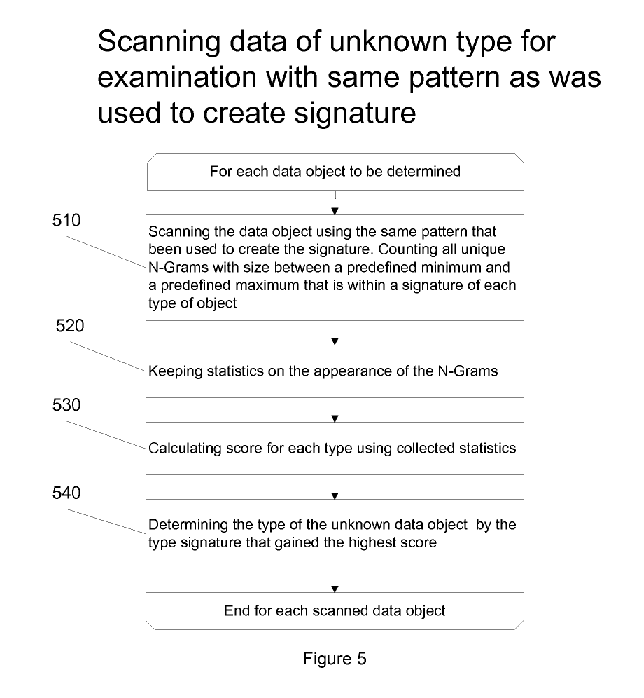

FIG. 5 shows a flowchart of scanning data of unknown type for examination with same pattern as was used to create signature, according to some embodiments of the present invention.

According to some embodiments of the present invention, for each data object of unknown type for examination, scanning the data object, using the same pattern that been used to create the signature. Counting all unique N-Grams with size between a predefined minimum and a predefined maximum that is within a signature of each type of object (stage 510). Next, keeping statistics regarding the appearance of the N-Grams (stage 520). Using the statistics that were kept to calculate a score for each type for the data object (stage 530). Determining the type of unknown data object by the type signature that gained the highest score from all scores that were calculated in stage 530 (stage 540).

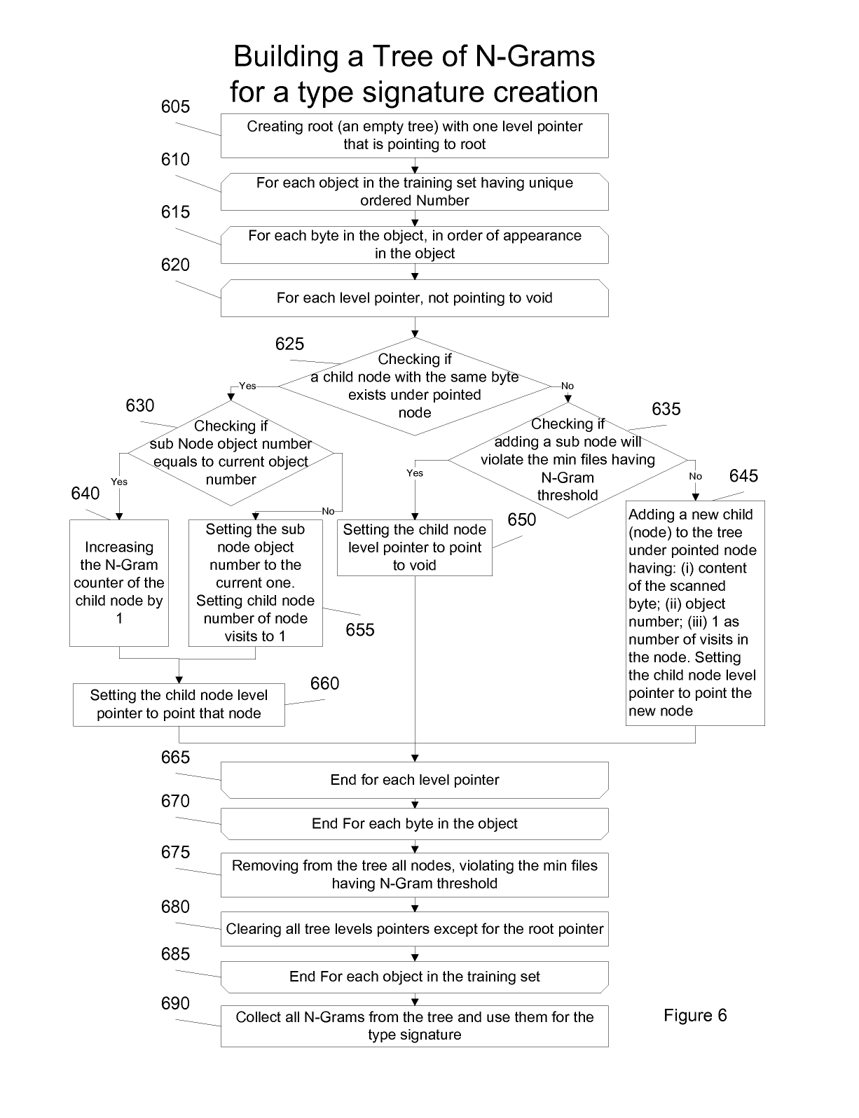

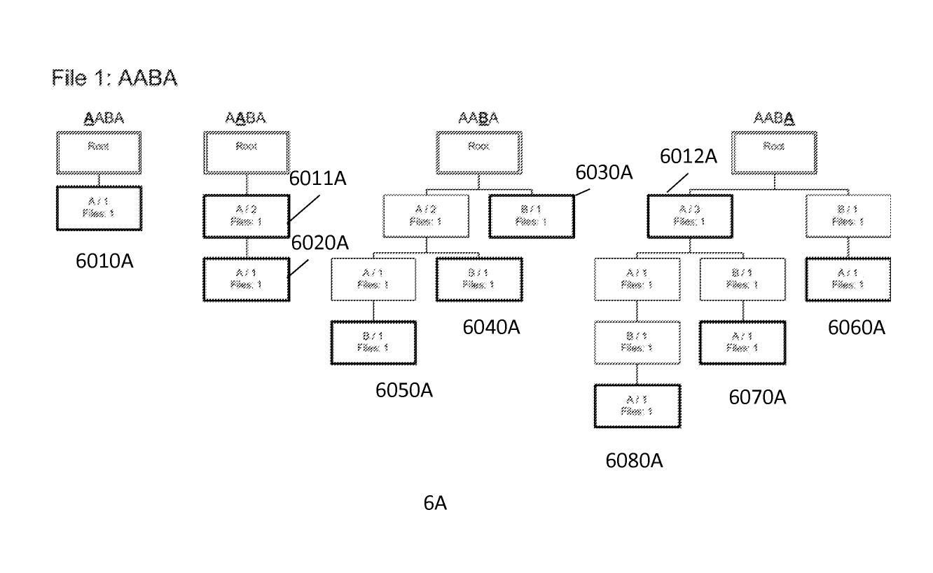

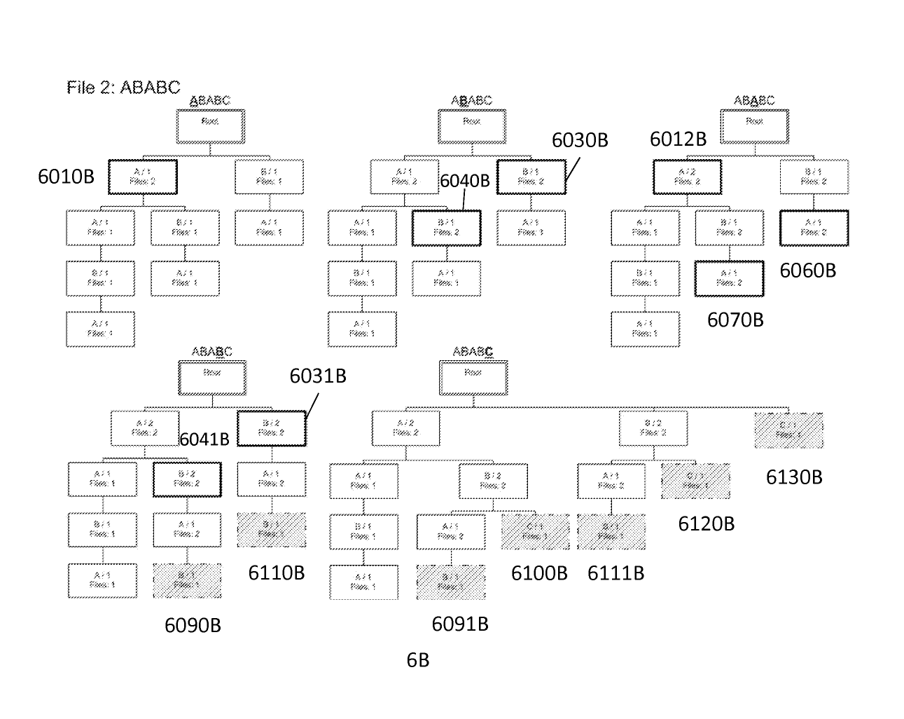

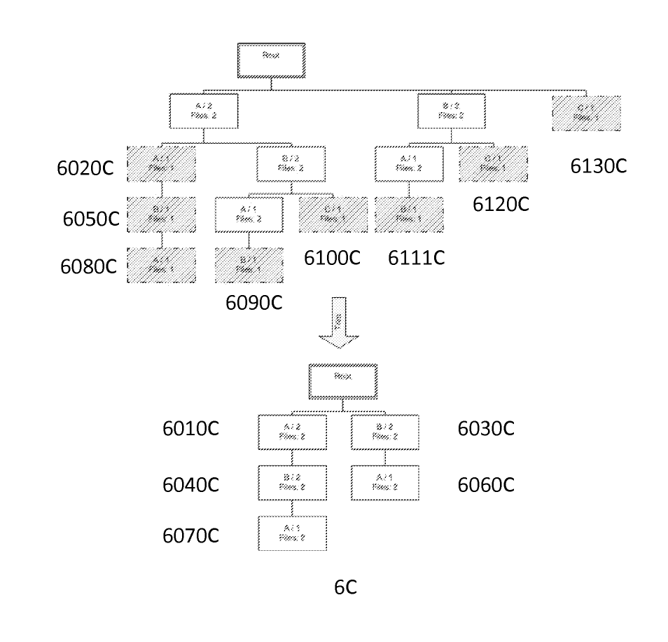

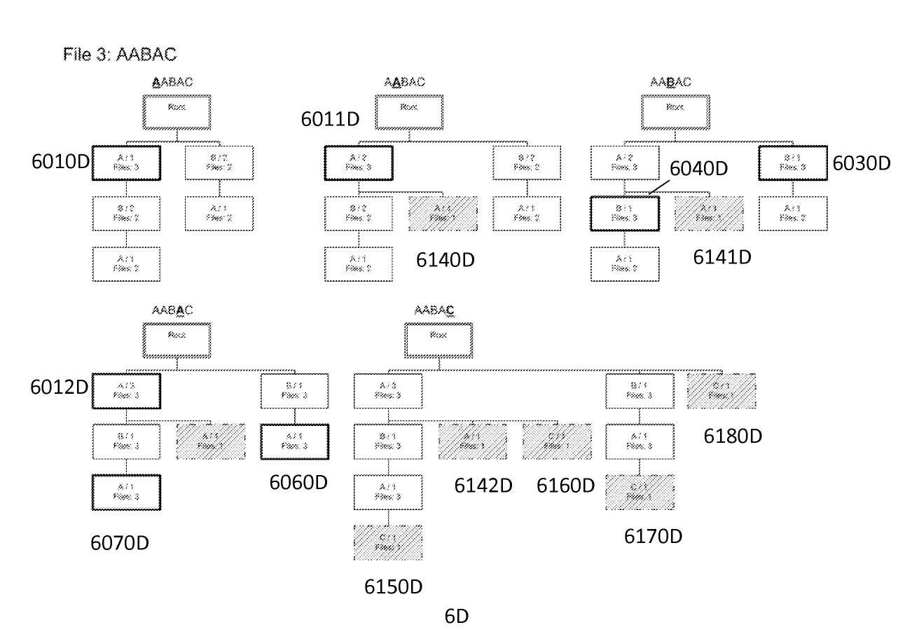

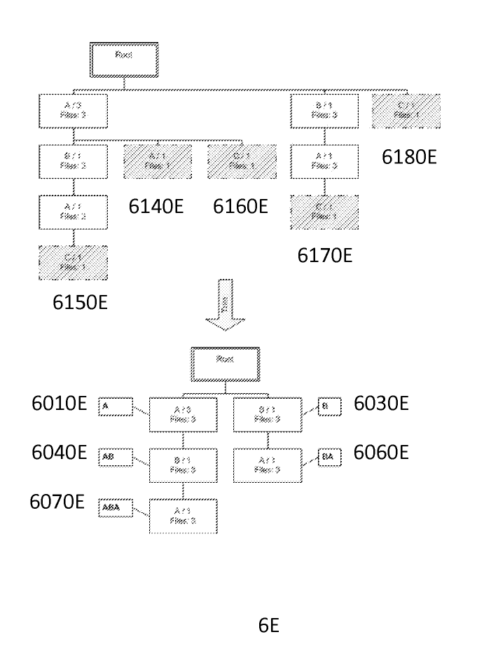

FIG. 6 shows a flowchart of a process of building a tree of N-Grams for a type signature creation, according to some embodiments of the present invention.

According to some embodiments of the present invention, a tree node represents a unique N-Gram. It holds information on the last byte of the N-Gram, the last file that visited it and additional statistical information such as (but not limited to) the numbers of visits in the current file, the location in the file for each visit etc.

The value of N-Gram may be extracted from the node by starting at the root and following a path in the tree to the node, while collecting all bytes in the nodes in the path and keeping the path order.

Additionally, there is a queue of pointers with a pointer for each tree level (depth), pointing to the last node that was visited on that level. In case there is no node to point to at some level, the pointer for this level points to nothing (void) but maintains the level. At each step, each pointer moves one level down and a new pointer is added, pointing the root.

If a maximum depth was defined, or if the tree has reached his depth limitation (after trimming process), the pointer, which pointed to the last level, will point to the root on the next step instead of creating a new pointer.

According to some other embodiments of the present invention, building a tree of N-Grams for a type signature creation begins with creating root (i.e. an empty tree) with one level pointer that is pointing to root (stage 605).

According to some other embodiments of the present invention, for each object in the training data set having unique ordered number stages 610 till stage 685 are taking place. For each byte in the object, in order of appearance in the object stages 615 till 670 are taking place, and for each level pointer that is not pointing to nothing (i.e. void) stages 620 till 665 are taking place.

According to some other embodiments of the present invention, checking if a child node with the same byte exists under the pointed node (stage 625). In case, a child node with the same byte exists under a pointed node, checking if sub node object number equals to current object number (stage 630). In case, sub node object number equals to current object number, increasing the N-Gram counter of the child node by 1 (stage 640). In case, sub node object number does not equal to current object number, setting the sub node object number to the current one and setting child node number of node visits to 1 (stage 655). After stage 640 or stage 655 setting the child node level pointer to point that node (stage 660).

According to some other embodiments of the present invention, in case, a child node with the same byte does not exist under a pointed node, checking if adding a sub node will violate the minimum files having N-Gram threshold (stage 635).

In case, adding a sub node will violate the minimum files having N-Gram threshold. Setting the child node level pointer to point to void (i.e. pointing to nothing) (stage 650). In case, adding a sub node will not violate the minimum files having N-Gram threshold, adding a new child (node) to the tree under pointed node having: (i) content of the scanned byte; (ii) object number; (iii) 1 as number of visits in the node and setting the child node level pointer to point to the new node (stage 645).

According to some other embodiments of the present invention, at the end of each object, removing from the tree all nodes that are violating the minimum files having N-Gram threshold (stage 675). Next, clearing all tree levels pointers except of the root pointer (stage 680).

According to some other embodiments of the present invention, after end of all stages for all objects in the training set (stages 610 till 685) collecting all N-Grams from the tree and use them for the signature of the object type (stage 690).

FIGS. 6A-6E demonstrates an example of the process of building a tree of N-Grams for a type signature creation, according to some embodiments of the present invention.

The example is based on scanning of three files in the following order: ‘AABA’, ‘ABABC’, ‘AABAC’.

The example is based on setting a threshold for the number of N-Grams in files to 100%, meaning that an N-Gram should be found in each one of the files in order to be added to the signature.

FIG. 6A demonstrates a process of adding to the tree of N-Grams for a type signature creation while scanning a file. An empty tree is initialized with an empty root node. Each node that was last visited is marked with bold frame. The root node is always marked as last visited. When a file is scanned each of the last visited nodes is inspected. The file ‘AABA’ starts with the character ‘A’. Since there is no child node to the root node with the character ‘A’, a new node 6010A with the character ‘A’ is added under root. This node is marked as been visited by 1 file and 1 occurrence in that file. The root node and node 6010A are now marked as last visited. Next, when the following character ‘A’ in the file is scanned the 2 last visited nodes are checked. The root node has a child node 6011A with ‘A’ that was visited on this file, so the visited counter is updated to 2. Node 6011A has no child node with ‘A’ so a new node 6020A with the character ‘A’ is added as a child node to it. This node is marked as been visited by 1 file and 1 occurrence in that file. This procedure is repeated for ‘B’, where 6030A, 6040A and 6050A are added and for the last ‘A’ where 6060A, 6070A and 6080A are added and node 6012A is marked as visited 3 times.

FIG. 6B demonstrates addition to the tree of N-Grams for a type signature creation. Before a new file is scanned, all pointers to the last visited nodes are cleared except for the root node. When file ‘ABABC’ is scanned starting with the character ‘A’, node 6010B is updated with the following information ‘A’ was found in 2 files and was found one time on the last visited file. Next, when character ‘B’ is scanned nodes 6030B and 6040B are updated with the following information ‘B’ was found in 2 files and was found one time on the last visited file. Next, when character ‘A’ is scanned node 6012B is updated with the following information ‘A’ was found in 2 files and was found two times on the last visited file. Also, nodes 6060B and 6070B are updated with the following information ‘A’ was found in 2 files and was found one time on the last visited file. Next, when character ‘B’ is scanned nodes 6031B and 6041B are updated with the following information ‘B’ was found in 2 files and was found 2 times on the last visited file. Also, new nodes 6090B and 6110B are added but since they were not found in the first file, they are marked for deletion and are not pointed to as last visited. Next, when character ‘C’ is scanned node 6100B, 6120B and 6130B are added with the following information ‘C’ was found in 1 file and was found one time on the last visited file but since they were not found in the first file, they are marked for deletion and are not pointed to as last visited. Also, nodes 6091B and 6111B remains marked for trimming from the tree.

FIG. 6C demonstrates Trimming step in which nodes 6020C, 6050C, 6080C, 6090C, 6100C, 6111C, 6120C and 6130C are trimmed. The tree after trimming is left with nodes 6010C, 6040C, 6070C, 6030C and 6060C.

FIG. 6D demonstrates addition to the tree of N-Grams for a type signature creation. When file ‘AABAC’ is scanned starting with the character ‘A’, node 6010D is updated with the information ‘A’ was found in 3 files and was found one time on the last visited file. Next, when the following character ‘A’ in the file is scanned node 6011D is updated with the information ‘A’ was found in 3 files and was found 2 times on the last visited file and node 6140D is added but since it was not found in the last 2 files, it is marked for deletion and is not pointed to as last visited. Next, when the following character ‘B’ in the file is scanned nodes 6040D and 6030D are updated with the information ‘B’ was found in 3 files and was found one time on the last visited file. Next, when the following character ‘A’ in the file is scanned node 6012D is updated with the information ‘A’ was found in 3 files and was found 3 times on the last visited file and nodes 6070D and 6060D are updated with the information ‘A’ was found in 3 files and was found one time on the last visited file. Next, when the following character ‘C’ in the file is scanned nodes 6150D, 6160D, 6170D and 6180D are added but since they were not found in the first two files, they are marked for deletion and are not pointed to as ‘last visited’.

FIG. 6E demonstrates trimming and final results. Nodes 6150E, 6140E, 6160E, 6170E and 6180E are trimmed. Node 6010E represents ‘A’, node 6040E represents ‘AB’ node 6070E represents ‘ABA’ node 6030E represents ‘B’ and node 6060E represents ‘BA’.

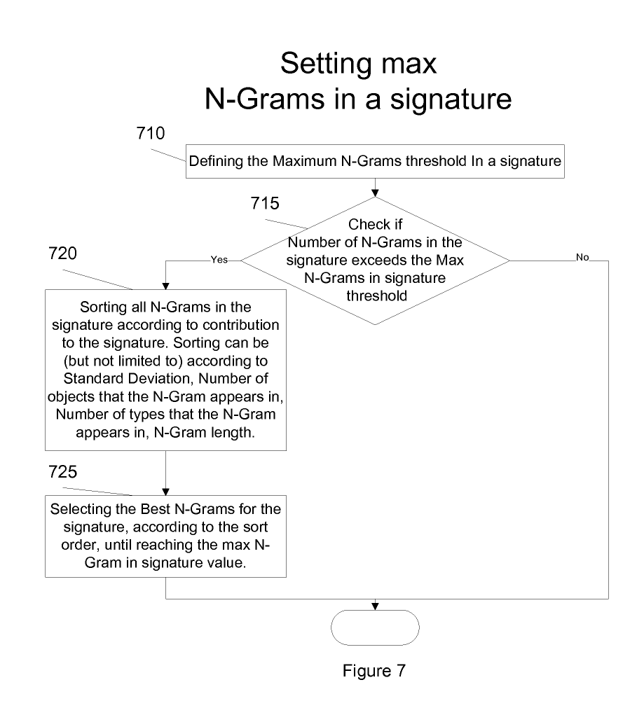

FIG. 7 shows a flowchart of a process of setting max N-Grams in a signature, according to some embodiments of the present invention.

According to some embodiments of the present invention, defining maximum N-Grams threshold in a signature of an object type (stage 710) and then checking if the number of N-Grams in the signature exceeds the maximum N-Grams in the signature threshold (stage 715). In case, the number of N-Grams in the signature exceeds the maximum N-Grams in the signature threshold, sorting all N-Grams in the signature according to contribution to the signature. The sorting may be (but not limited to) according to standard deviation, number of objects that the N-Gram appears in, number of types of objects that the N-Gram appears in, N-Gram length (stage 720). Next selecting the best N-Grams for the signature, according to the sort order, until reaching the maximum N-Gram in signature threshold value (stage 725).

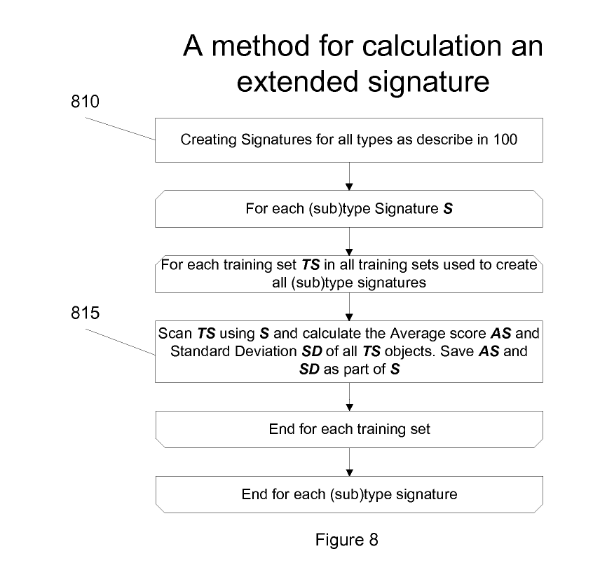

FIG. 8 shows a flowchart of a process of creating an extended object type signature based on the result of inspecting all objects in all types training sets using the basic signature that was created for the object type, according to some embodiments of the present invention.

According to some embodiments of the present invention, alternatively, to overcome uncertainty as to the type of an examined object the following process of signature creation may be implemented. The process may start with creating signatures for all types of objects as illustrated in FIG. 1. (stage 810). Next, check repeatedly, for each type or sub type signature, and for each training set in all training sets used to create all type or sub type signatures, preform the following: scan training set using the type or sub type signature and calculate the Average Score and Standard Deviation of all objects in the training set. The value of the average score and the standard deviation is saved as part of the type or sub type signature (stage 815).

For example, scanning Hypertext Markup Language (HTML) training set and Photographic Expert Group (JPEG) training set using the Hypertext Markup Language (HTML) signature and adding the average score and standard deviation of both training sets to the Hypertext Markup Language (HTML) signature.

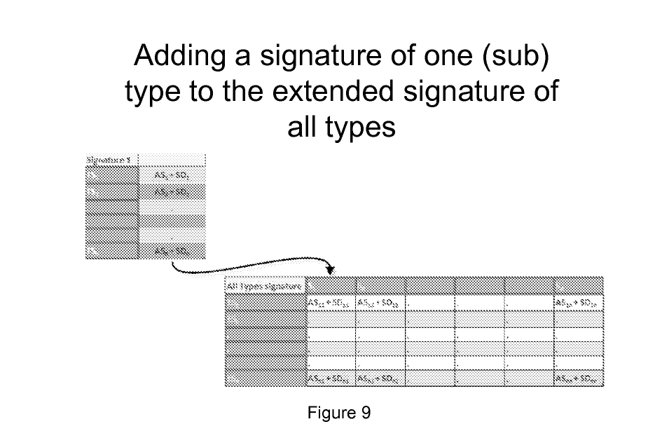

FIG. 9 shows a flowchart of adding the results of one type or sub type extended signature to a Matrix representing all types signature. Each matrix column represent a signature for a specific type or sub type, where TS stands for Training Set, AS stands for Average Score, SD stands for Standard Deviation and S stands for Signature.

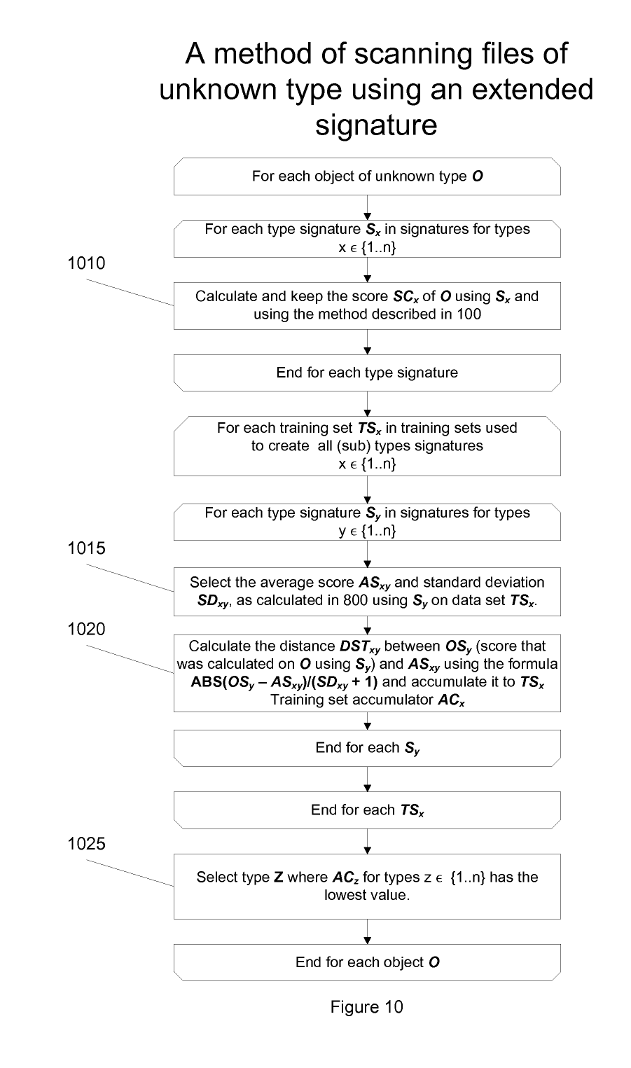

FIG. 10 shows a flowchart of the process of scanning an examined object of unknown type and determining its type by calculating its score using the signature created using the process described in FIG. 8.

According to some embodiments of the present invention, for each examined object that its type is unknown and for each type signature in all signature types that were found, calculate and keep a score of the examined object using the type signature and the method that was used for creating the signature as described in FIG. 1 (stage 1010).

According to some embodiments of the present invention, for each training set ‘X’ in all training sets used to create all type signatures and for each type signature ‘Y’ in all signature types, select the average score ‘XY’ and standard deviation ‘XY’ as calculated in FIG. 8, from signature ‘Y’. Meaning, average score and standard deviation that were calculated using signature ‘Y’ on training set that was used to create signature ‘X’ (stage 1015). Next, calculate the distance parameter ‘XY’ between object score ‘Y’ that was calculated on the examined object using signature ‘Y’ and average score ‘XY’ using the formula ABS(object score ‘Y’−average score ‘XY’)/(standard deviation ‘XY’+1) and accumulate it to accumulator ‘X’ of training set ‘X’ (stage 1020).

According to some embodiments of the present invention, select type ‘Z’ where the accumulated value ‘Z’ is the lowest of accumulated values for all types (stage 1025).

In a non-limiting example, below is a sample for calculating a score for a signature based on scores of different types of objects. In the sample there are four training sets for the types: (i) djvu; (ii) epub; (iii) exe; and (iv) jpg.

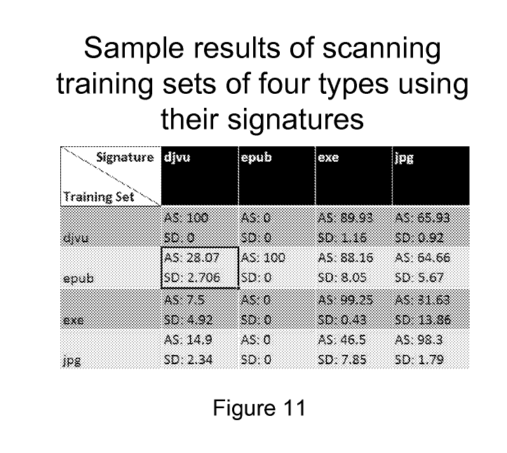

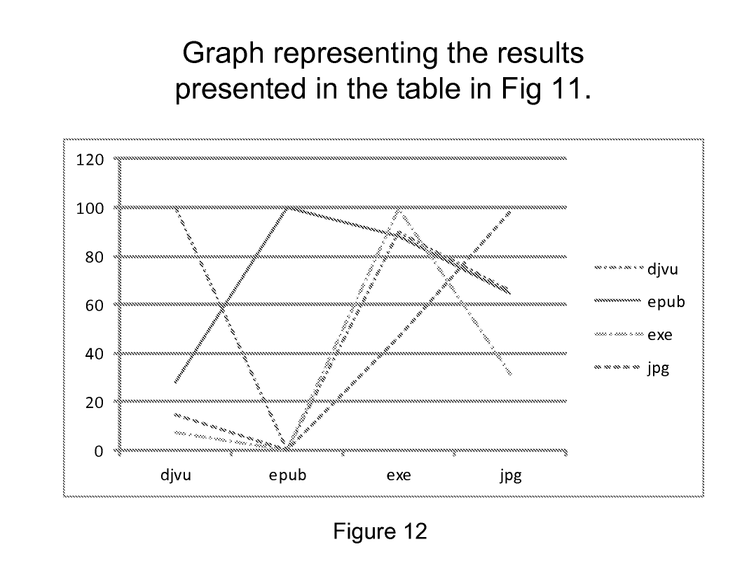

The first step is to create a signature based on the process that is illustrated in FIG. 1. The result of the process is a signature that is containing a list of N-Grams and their collected statistics. Next, each training set is scanned using the signatures as illustrated in FIG. 8. A sample result is presented in FIG. 11.

In a table in FIG. 11 each column presents the Average Score and Standard Deviation, which are the result of scanning of the training sets of all object types, listed in the row titles, using the signature of the type listed on the column title. For instance, looking at the marked pair, the result of scanning ‘epub’ training set using ‘djvu’ signature is the average score 28.07 and standard deviation 2.706.

FIG. 12 illustrates a graph which presents result of the table (in FIG. 11). Each graph line represents different type training set. The vertical axis represents the average score that the type training set achieved when scanned using signatures of types, listed on the horizontal axis.

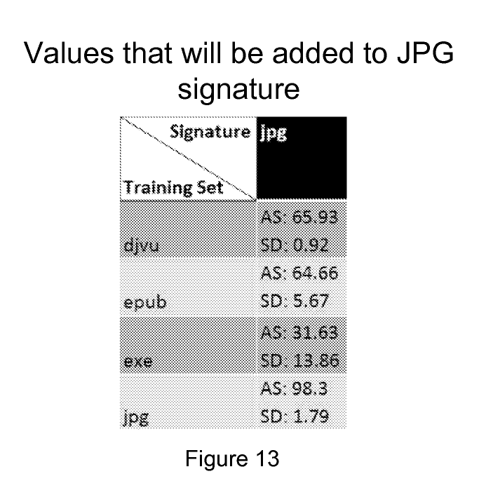

For each type signature, column values are added as part of the signature. FIG. 13 illustrates an example of data that will be added as part of jpg signature (taken from the right column of the table in FIG. 11).

When determining the type of an object of an unknown type the first step is to scan the content of the object of the unknown type, and extract the score for each type signature, based on the method that is described in FIG. 5.

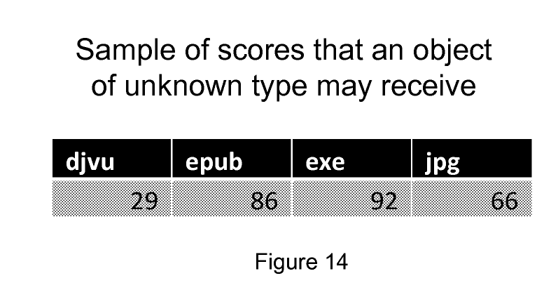

Next, calculating the distance of scores, which were received from the previous step, from the average scores that were calculated in the signature creation step based on the method described in FIG. 8. In a non-limiting example, an object of unknown type may receive scores as illustrated in FIG. 14.

To calculate the distance of the scores for each type training set the following formula may be used:

SUM(ABS(OS ‘Y’−AS ‘XY’)/(SD ‘XY’+1)) for type training set x and Average Scores and Standard Deviations from all type signatures (y). Where:

OS ‘Y’ is an Actual score that the object received using type signature y.

AS ‘XY’ is an Average score that Type y signature received for training set of type x.

SD ‘XY’ is a Standard deviation that Type y signature received for training set of type x.

For example, based on the data in FIGS. 11-14, the distance of the object score, based on ‘exe’ training set, from ‘djvu’ signature will be calculated as follows:

ABS(29−7.5)/(4.92+1)=3.63

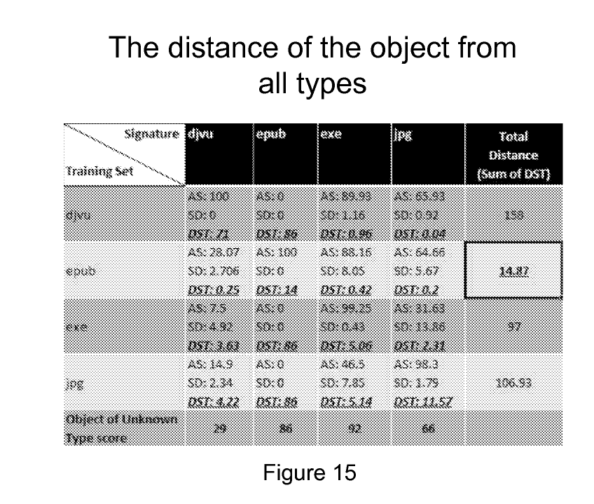

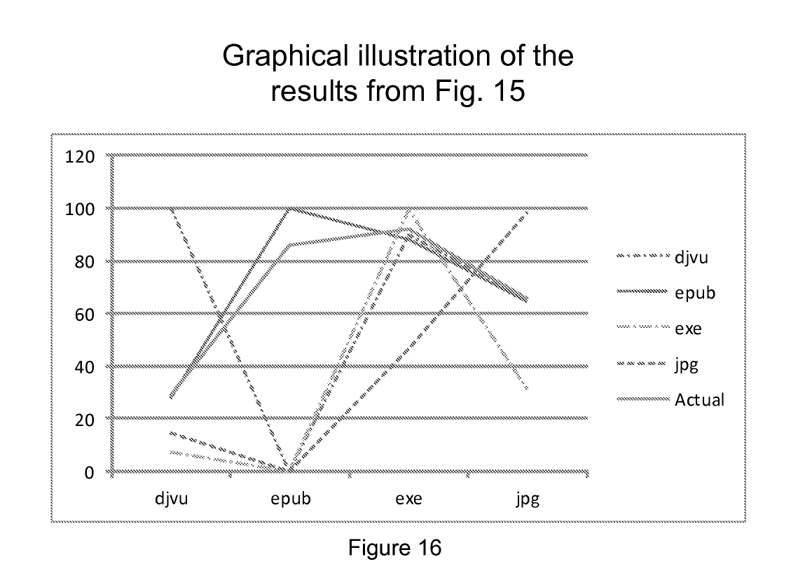

FIG. 15 illustrates a table listing the distances of the object from all types:

The actual score for a type is the sum of its distances from all type signatures for the alleged type training set.

For example, the score for Type exe is the sum of the scores it received for type signatures of djvu, epub, exe and jpg for type exe training set:

3.63+86+5.06+2.31=97

As one can see in FIG. 15, the distance of the object from the type ‘epub’ is the smallest, hence, the best guess is that the object is of type ‘epub’.

The distance is illustrated in a graph in FIG. 16. As can be seen, the actual object results resemble the ‘epub’ graph.

The present invention may be implemented in the testing or practice with methods and materials equivalent or similar to those described herein.

Meanings of technical and scientific terms used herein are to be commonly understood as by one of ordinary skill in the art to which the invention belongs, unless otherwise defined.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method for revealing a type of data, the method comprising the steps of:
receiving at least one training data set of objects to create a signature for that data type;
creating the signature, by: (i) scanning all objects in each training data set, to create a list of unique N-Grams of any size and their statistics; and (ii) adding each N-Gram in the list in case it appears in a minimum of predefined threshold objects to a repository,
wherein each signature includes at least one N-Gram, wherein size of the at least one N-Gram is variable having a minimum limitation,
wherein a temp maximum value is specified for the size of the at least one N-Gram, and
wherein the temp maximum value for the size of the at least one N-Gram is increased after the creating of the signature when at least one identified N-Gram in the creation process reach the temp maximum value, and
receiving data of unknown type for examination;
scanning said received data of unknown type to score each N-Gram in the signature of each object type when it is found in the scanned data; and
determining the type of the unknown type data according to the signature of the object type that accumulated highest score by the N-Grams of the signature.

2. The method of claim 1, further comprising the step of defining a range of thresholds for maximum standard deviation and removing objects not in the range of threshold in the signature creating step from a training data set.

3. The method of claim 1, wherein in the creating of the signature, order of the objects that are being scanned is determined according to size of the objects.

4. The method of claim 1, wherein the scanning of: (i) each object in the training data set to create a signature; and (ii) said received data of unknown type, is applied on fractional sections of the object by using a predefined scanning pattern which defines the relative location and size of each section.

5. The method of claim 1, wherein an N-gram that appears in more than one type signature receives a low score.

6. The method of claim 1, wherein the creating of one type signature is from multiple signatures.

7. The method of claim 1, wherein settings are applied for specified object types.

8. The method of claim 1, wherein the creating of the signature is utilizing a data structure of a tree structure, wherein each node includes one byte and represents one potential N-Gram beginning at the root of the tree.

9. The method of claim 8, wherein through the signature creation processing new nodes are added to the tree in case the number of appearances of the corresponding N-gram in all scanned objects is with the limits of predefined threshold.

10. The method of claim 9 wherein after scanning each object, trimming nodes which their corresponding N-gram number of appearances in all scanned objects is not with the limits of predefined threshold.

11. The method of claim 1, wherein the preparing of the training data set is comprising the steps of:
creating one group of objects (i.e. centroid) for each object in the training data set and keeping it in the first data storage;
for each centroid pairs in the first data storage, calculating the signature of an intersection of the centroids,
repeatedly taking the following steps, while there is more than one centroid left in the first data storage:
(a) selecting an ordered pair of centroids from the first data storage yielding the best signature by intersection,
(b) merging the ordered pair of centroids to yield a new centroid;
(c) keeping the new centroid in the first data storage;
(d) copying the new centroid with its related signature to the second data storage;
(e) removing the ordered pair of centroids that was used to create the new centroid from the first data storage; and
(f) repeatedly calculating the signatures for the intersection of the new centroid and each of the rest of the centroids in the first data storage;
(g) selecting centroids from the second data storage, in reverse order of creation, as training data sets in case: (i) the signature of the centroid meets predefined criteria; and (ii) the centroid is not included in another centroid that was selected earlier.

12. The method of claim 1, wherein during the signature creation after scanning each object checking each N-Gram that was added to the repository and removing all N-Grams that appear in less objects in the training data set than the N-Grams in objects' threshold.

13. The method of claim 1, during the signature creation wherein for each object type, N-Grams are sorted by specified criteria for contribution to the type signature and N-Grams having low contribution to the type signature are removed.

14. The method of claim 1, further comprising the steps of scanning each training data set of each type signature using signatures of all types and, calculating an average score and standard deviation of all objects in the training data sets and saving it as an attribute of the signature used for scanning the training data set.

15. The method of claim 14, further comprising the step of: calculating distance parameters of the score of examined object by signature from the average scores taking into account standard deviations received by scanning each type training data set by the alleged signature.

16. The method of claim 15, further comprising the step of: summing up the distance parameters for each type training data set and selecting the type where the result of the respective type training data set is the lowest.

17. The method of claim 1, wherein the method is further recreating the signature after temp maximum value for the size of the at least one N-Gram is increased.
